(19) United States
(12) Patent Application Publication
(10) Pub. No.: US 2004/0107375 A1
(43) Pub. Date: Jun. 3, 2004

(54) System and method for switching clock sources

(76) Inventor: Edward Anglada, Aguadilla, PR (US)

Correspondence Address: HEWLETT-PACKARD COMPANY, Intellectual Property Administration, P. O. Box 272400, Fort Collins, CO, 80527-2400, US

(21) Appl. No.: 10/307,714

(22) Filed: Dec. 2, 2002

(51) Int. Cl. G06F 1/12

(52) U.S. Cl. 713/400

(57) ABSTRACT

A system and method for switching clock sources is presented. The disclosed approach permits an external controller to switch a clock source for a plurality of system boards. The external controller generates a command, which is relayed to system boards on a multi-system chassis. Each system board receives the command and switches its clock source in response to the received command.

### BACKGROUND

In many computer systems, a maximum operational clock frequency of an electronic circuit is dictated by critical paths, which are circuit paths where combinational delays are greater than the time allocated for data transmission at the operational clock frequency. Critical paths may be identified using an iterative process in which a known input data is supplied to a processor at various operational clock frequencies. Actual output data of the processor is compared with expected output data for each of the various operational clock frequencies. If there is no discrepancy between the actual output data and the expected output data for a given operational clock frequency, then it may be concluded that the maximum operational clock frequency has not been exceeded.

Similarly, the operating margin of various system boards (or electronic assemblies) may be tested by varying the operational clock frequency. Thus, for example, a system board manufacturer may increase or decrease the operational clock frequency during testing in order to determine whether or not a system is susceptible to errors due to fluctuations in operational clock frequencies.

In an environment, such as that shown in FIG. 1, where a system chassis 110 hosts a collection of system boards 150, the operational clock frequency may be changed by physically replacing a main clock on each system board 150. Thus, during testing, each system board 150 is often physically removed from a back-plane 140 and the main clock on that system board 150 is physically replaced. Upon replacement of the main clock with another clock having a different operational clock frequency, the system board 150 is inserted into the back-plane 140. After that system board 150 is inserted into the back-plane 140, an external controller 120 tests the operating margin of the system boards 150 by relaying various commands to the system boards 150 through a management board 130 that is electrically coupled to each of the system boards 150. If further testing is desired, then each system board 150 is removed again for clock replacement and reinserted into the back-plane 140.

As seen here, the iterative removal and reinsertion of the system boards 150 is very tedious and time consuming because each clock has to be replaced for each system board 150 on the chassis 10 for each test iteration of margin testing.

### SUMMARY

The present disclosure provides systems and methods for switching clock sources.

Briefly described, in architecture, one embodiment of the system comprises a low-overhead bus, a main clock, a clock-bypass circuit, and a clock selection circuit. The low-overhead bus is configured to engage a back-plane and receive a command from an external controller. The clock-bypass circuit is configured to receive the command, and to generate a secondary clock signal and a clock-select signal in response to the received command. The clock-selection circuit is configured to receive the secondary clock signal, the clock-select signal, and the main clock signal. The clock-selection circuit is further configured to select either the main clock signal or the secondary clock signal in response to the clock-select signal.

The present disclosure also provides clock-source-switching methods. In this regard, one embodiment of the method comprises generating a command from an external source, and switching clock sources on each of the plurality of system boards in response to the generated command.

### BRIEF DESCRIPTION OF THE DRAWINGS

The components in the drawings are not necessarily to scale, and like reference numerals designate corresponding parts throughout the several drawings.

FIG. 1 is a block diagram showing a multi-system chassis having a plurality of system boards.

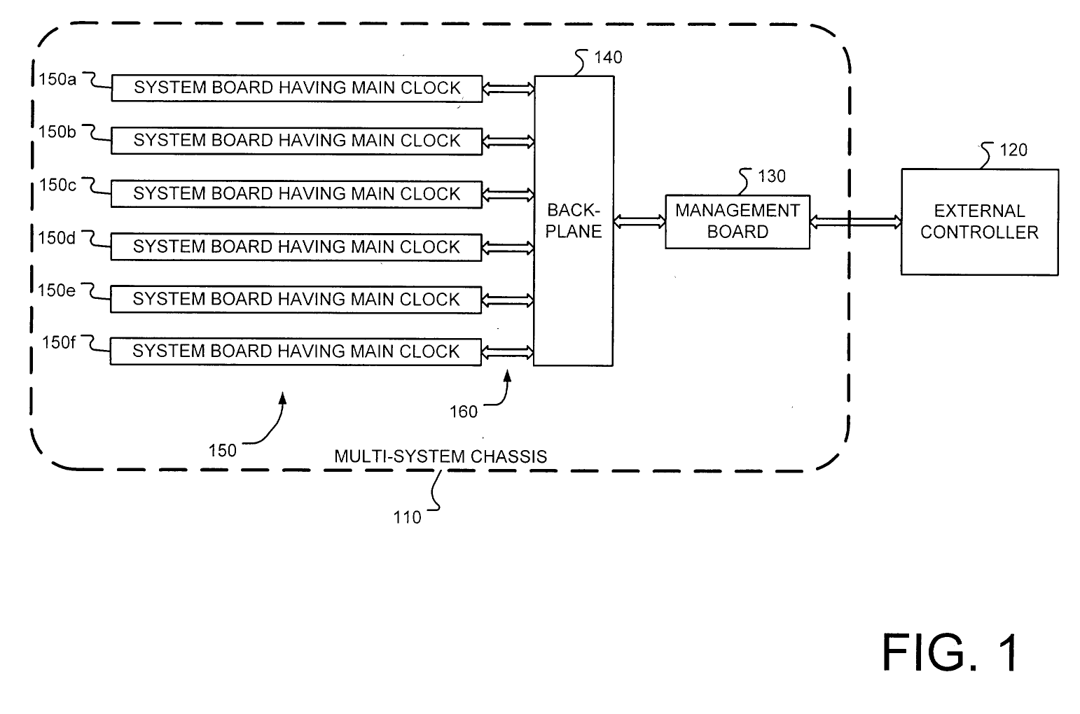

FIG. 2A is a block diagram showing one embodiment of a multi-system chassis having system boards, each having a clock-bypass circuit.

FIG. 2B is a block diagram showing another embodiment of multi-system chassis having system boards.

FIG. 3A is a block diagram showing one embodiment of the system board of FIG. 2A having a removable clock bypass card.

FIG. 3B is a block diagram showing another embodiment of the system board of FIG. 2A.

FIG. 3C is a block diagram showing one embodiment of the system board of FIG. 2B having a clock-bypass circuit

FIG. 4A is a block diagram showing one embodiment of the removable clock bypass card of FIG. 3A in greater detail.

FIG. 4B is a block diagram showing another embodiment of the removable clock bypass card of FIG. 3A in greater detail.

FIG. 4C is a block diagram showing the clock-bypass circuit of FIG. 3B in greater detail.

FIG. 5 is a flowchart showing one embodiment of the method, which may be performed by the external controller and the multi-system chassis.

FIG. 6 is a flowchart showing one embodiment of the method, which may be performed by the system boards.

FIG. 7 is a flowchart showing another embodiment of the method, which may be performed by the system boards.

### DETAILED DESCRIPTION

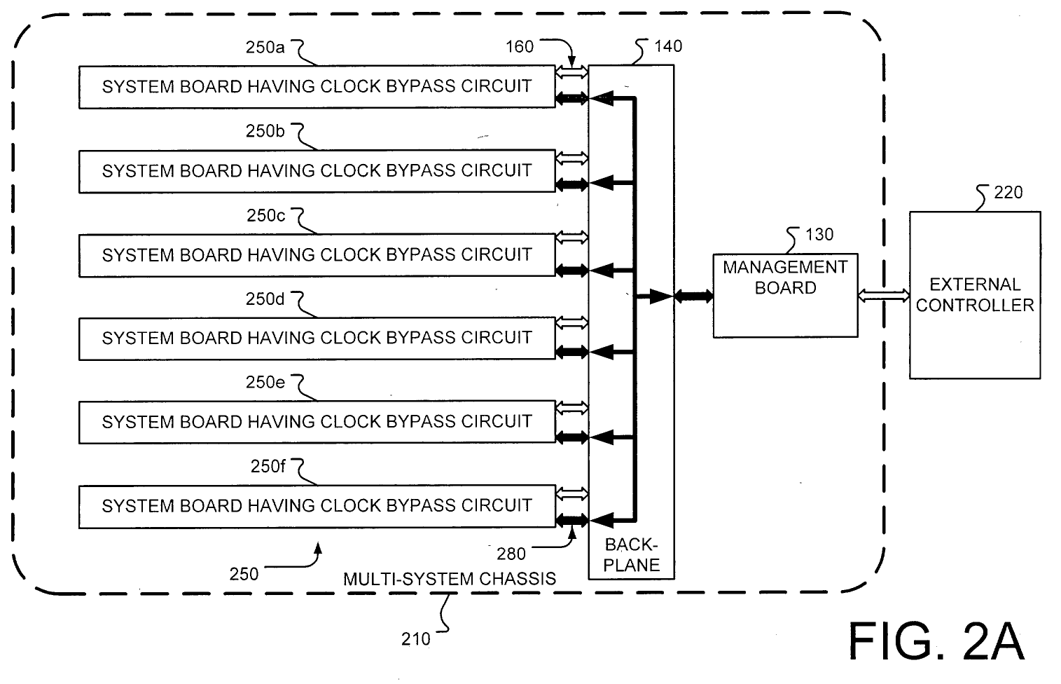

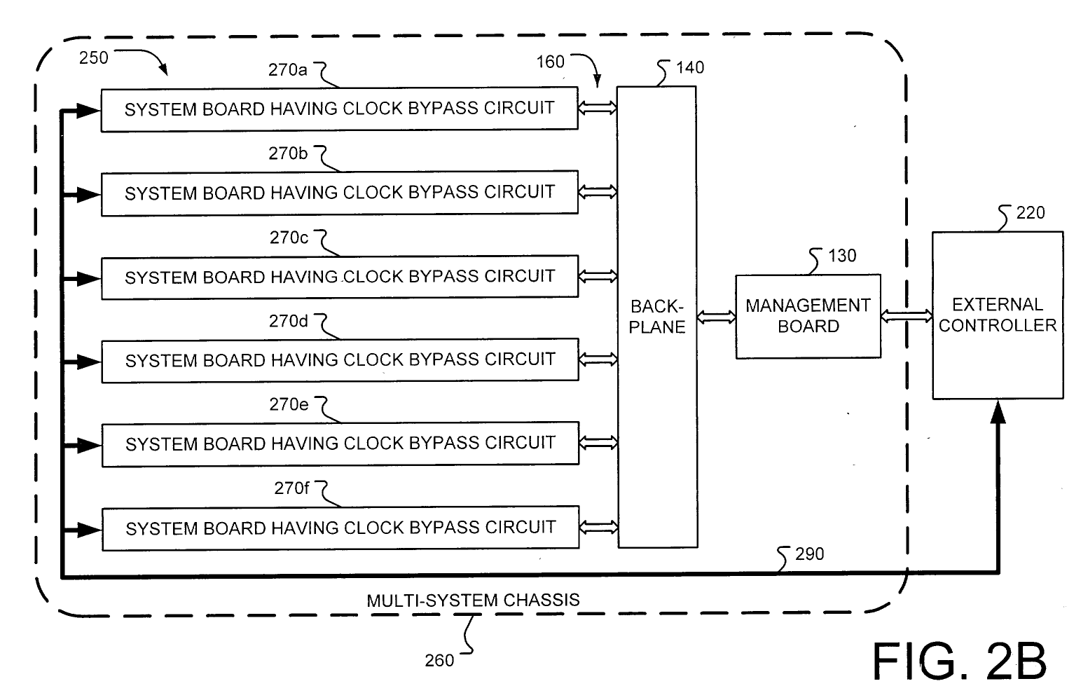

Reference is now made in detail to the description of the embodiments as illustrated in the drawings. As shown below with reference to FIGS. 2A through 7, several embodiments are presented in which a main clock source is bypassed using a secondary clock source that is generated in response to an external command. The embodiments shown in FIGS. 2A through 7 permit the switching of clock sources without physically removing system boards from a multi-system chassis, thereby simplifying margin testing of system boards.

FIG. 2A is a block diagram showing one embodiment of the system in which a multi-system chassis 210 has a plurality of system boards with clock-bypass circuits 250 (hereinafter referred to as modified system boards 250). Each modified system board 250 includes a clock-bypass circuit (not shown), which is configured to permit clock source switching without physically removing and reinserting each system board. As shown in FIG. 2A, each of the modified system boards 250 is electrically coupled to a back-plane 140 through electrical connectors 160 and low-overhead buses 280. The low-overhead buses 280 are dedicated buses that relay signals to and from a management board 130. The back-plane 140 is electrically coupled to the management board 130, which, in turn, is electrically coupled to an external controller 220. Given this configuration, the external controller 220 may perform margin testing on each of the modified system boards by generating a test command, which is cascaded through the management board 130 to the back-plane 140 and ultimately to the modified system board 250 through one of the low-overhead buses 280.

If each of the modified system boards 250 has a clock-bypass circuit (not shown) that permits the bypassing of a main clock on the modified system board 250, then the external controller 220 may access the clock-bypass circuit (not shown) via the management board 130 and the back-plane 140. Thus, rather than having to physically remove and reinsert each board to change the operational clock frequency, the external controller 220 may perform clock switching by simply issuing a command to the modified system boards 250.

While an external controller 220 is generically referenced as the device performing margin tests, the external controller 220 may be a general-purpose computer that is programmed to perform margin tests. Alternatively, the external controller 220 may be a specialized device that is configured to perform margin tests. In this sense, any device that generates appropriate commands and receives feedback in response to the commands may be used as the external controller 220.

FIG. 2B is a block diagram showing another embodiment of the system in which a multi-system chassis 210 has a plurality of system boards with clock-bypass circuits 270 (hereinafter referred to as modified system boards 270). Each modified system board 270 includes a clock-bypass circuit (not shown), which is configured to permit clock source switching without physically removing and reinserting each system board. As shown in FIG. 2B, each of the modified system boards 270 is electrically coupled to a back-plane 140 through electrical connectors 160. The back-plane 140 is further electrically coupled to a management board 130, which, in turn, is electrically coupled to an external controller 220. In addition to being coupled to the back-plane 140, the modified system boards 270 in this embodiment are coupled directly to the external controller 220 using a clock-select bus 290. Thus, if each of the modified system boards 270 has a clock-bypass circuit (not shown) coupled to the clock-select bus 290, then the external controller 220 may access the clock-bypass circuit directly through the clock-select bus 290. Thus, rather than having to physically remove and reinsert each board to change the operational clock frequency, the external controller 220 may perform clock switching by simply issuing a command to the modified system boards 270. Additionally, by having the clock-select bus 290 coupled to the clock-bypass circuit (not shown), the external controller need not traverse the management board 130 or the back-plane 140 to access the clock-bypass circuit (not shown). Thus, unlike the system of FIG. 2A in which the clock-bypass circuit (not shown) is accessed through the back-plane 140, the system of FIG. 2B permits the external controller 220 to directly access the clock-bypass circuit (not shown) through the clock-select bus 290.

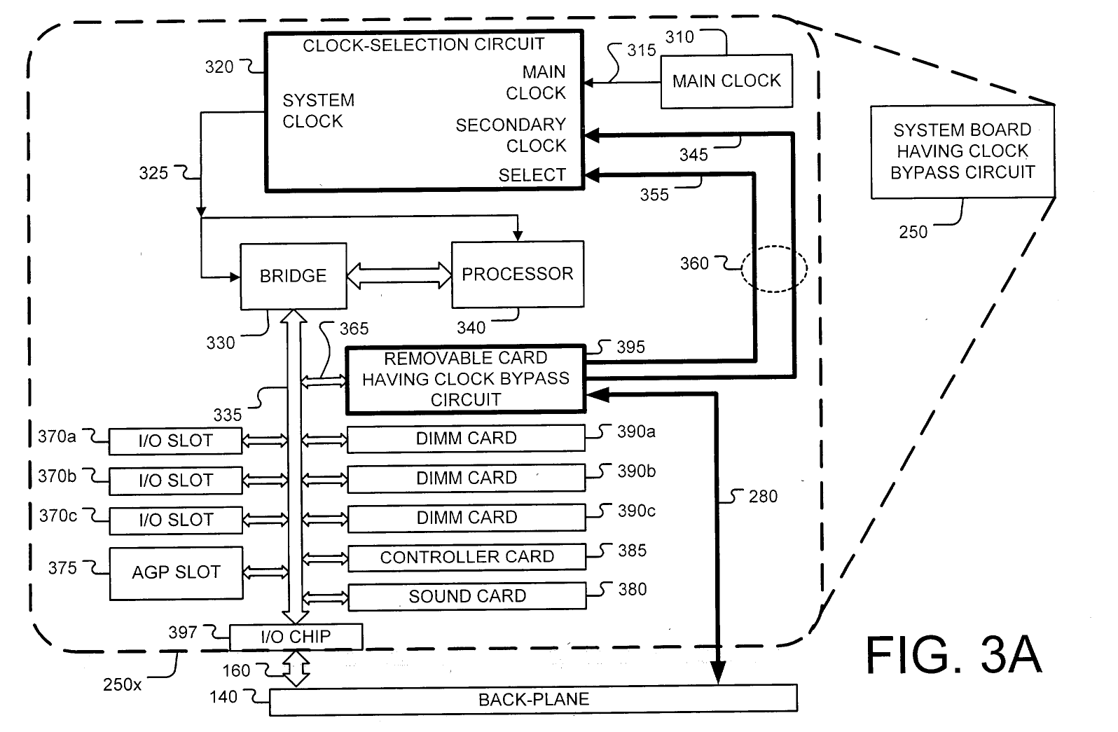

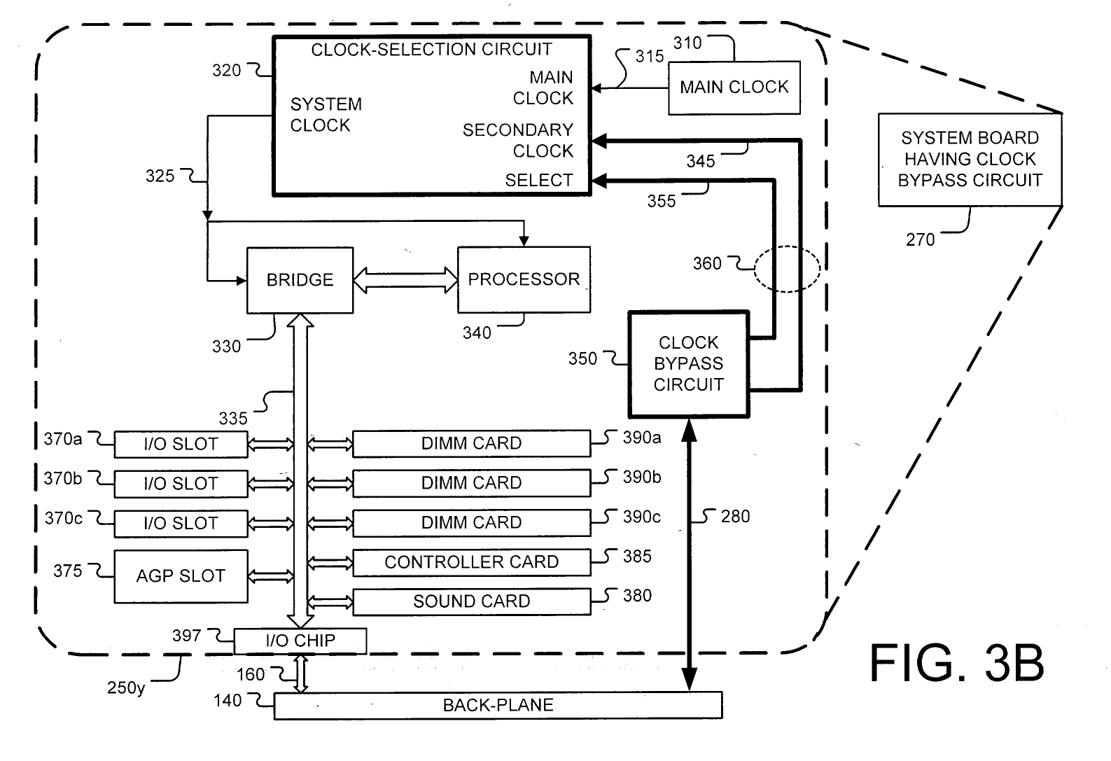

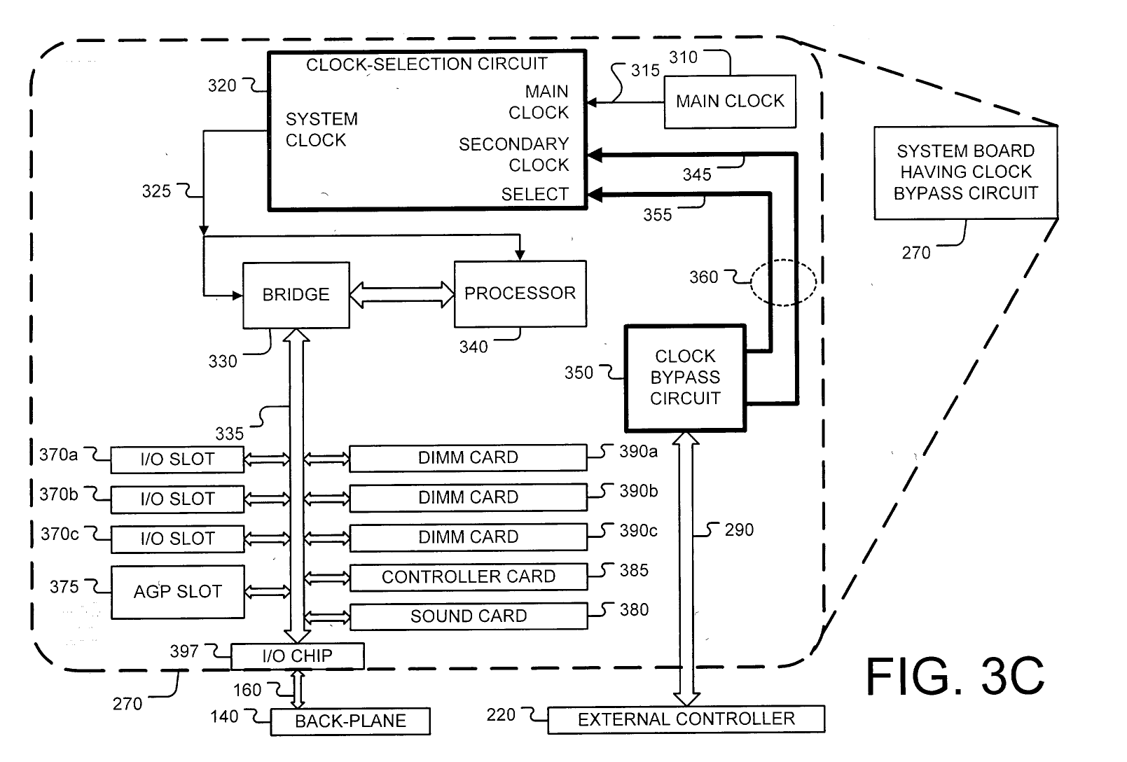

Having generally described several embodiments of a clock-source-switching system, attention is turned to FIGS. 3A through 3C, which show several embodiments of the modified system boards 250, 270 in greater detail.

FIG. 3A is a block diagram showing a modified system board 250x having a removable card 395 with a clock-bypass circuit (not shown). For simplicity, the removable card 395 is simply referred to hereinafter as a removable clock-bypass card 395. As shown in FIG. 3A, the modified system board 250x comprises a main clock 310 configured to generate a main clock signal 315. The main clock 310 is the default system clock that is used during normal operation (i.e., not during margin testing) of the modified system board 250x Additionally, the modified system board 250x comprises a clock-selection circuit 320 having a MAIN CLOCK input, a SECONDARY CLOCK input, a SELECT input, and a SYSTEM CLOCK output. Since there is no secondary clock source during normal operation, the clock-selection circuit 320 receives the main clock signal 315, selects the main clock signal 315, and outputs the main clock signal 315 at the SYSTEM CLOCK output as the system clock signal 325 during normal operation.

While there are several different ways of implementing a clock-selection circuit 320, the clock-selection circuit 320 in one embodiment is implemented as a phase-locked loop (PLL) circuit. The PLL circuit is configured to receive a clock-select signal 355 and two clock signals (e.g., a main clock signal 315 and a secondary clock signal 345). Upon receiving the two clock signals, the PLL circuit selects one of the two clock signals as the system clock signal 325 depending on the value of the clock-select signal 355.

In another embodiment, the clock-selection circuit 320 may be implemented using a two-input-one-output (2×1) multiplexer (MUX) having a select node. In this sense, each of two clock signals is input to one of the two MUX inputs, and the clock-select signal 355 is input to the select node of the MUX. Thereafter, one of the clock signals is output at the MUX output depending on the value of the clock-select signal 355. Other similar circuits may be used as the clock-selection circuit 320 if the circuits are capable of (1) receiving at least two clock signals, (2) selecting one of the received clock signals, and (3) outputting the selected clock signal.

Continuing with the embodiment of FIG. 3A, the modified system board 250x further comprises a bridge 330 and a processor 340, which are configured to receive the system clock signal 325 from the clock-selection circuit 320. Thus, the operational clock speed of the bridge 330 and the processor 340 are determined by the system clock signal 325. The bridge 330 is electrically coupled to the processor 340 and a system bus 335, and the system bus 335 is coupled to various components on the modified system board 250x. In this sense, the bridge 330 interfaces the processor 340 to the various system components, thereby permitting the processor 340 to control the operations of each of the various components. Additionally, the system bus 335 is coupled to an input/output (I/O) chip 397, which interfaces the modified system board 250x to the back-plane 140 through the electrical connector 160. In one embodiment, the various components include a plurality of dual-inline-memory module (DIMM) cards 390a, 390b, 390c, a controller card 385, a sound card 380, and various slots configured to receive peripheral devices. The various slots may include I/O slots 370a, 370b, 370c, an advanced graphics port (AGP) slot 375, and various other slots configured to engage peripheral devices.

A removable clock-bypass card 395 is included in the embodiment of FIG. 3A, thereby permitting the modified system board 250x to change clock sources without physical removal of the modified system board 250x from the back-plane 140. As shown in FIG. 3A, the removable clock-bypass card 395 is coupled to the system bus 335. Thus, if there are additional components on the removable clock-bypass card 395, then these additional components may be controlled by the processor 340 through a circuit bus 365. Additionally, the removable clock-bypass card 395 is coupled to the back-plane 140 through a low-overhead bus 280. Since the back-plane 140 is accessible to the external controller 220 through the management board 130, the removable clock-bypass card 395 is also accessible to the external controller 220 since it is electrically coupled to the back-plane 140 through the low-overhead bus 280. In this sense, the external controller 220 may access the removable clock-bypass card 395 through the management board 130 and the back-plane 140 using the low-overhead bus 280. The management board 130 typically directs signals from the external controller 220 to specific system boards 270, and vice versa.

In operation, the external controller 220 generates a clock-bypass command in order to switch the system clock of the modified system board 250x. The clock-bypass command is relayed to the removable clock-bypass card 395 through the management board 130 and the back-plane 140 via the low-overhead bus 280. Once the removable clock-bypass card 395 receives the clock-bypass command, the removable clock-bypass card 395 generates a clock-select signal 355 and a secondary clock signal 345. The generated secondary clock signal 345 and the clock-select signal 355 are relayed to the clock-selection circuit 320. At this point, the clock-selection circuit 320 receives the main clock signal 315, secondary clock signal 345, and the clock-select signal 355 at the MAIN CLOCK input, the SECONDARY CLOCK input, and the SELECT input, respectively. In an alternative embodiment, the secondary clock signal 345 may also be generated by an external clock (not shown), which directs the generated secondary clock signal 345 to the clock-selection circuit 320 of each system board through the backplane 140. In this regard, the external clock (not shown) may be co-located with the external controller 220 in one embodiment of the invention.

In response to receiving the clock-select signal 355 and the secondary clock signal 345, the clock-selection circuit 320 selects the secondary clock signal 345 as the system clock signal 325. The secondary clock signal 345 is then output from the clock-selection circuit 320 at the SYSTEM CLOCK output as the system clock signal 325. The operational clock frequency of the modified system board 250x is set by the system clock signal 325 for use by the bridge 330 and the processor 340. The bridge 330 provides the processor 340 access to one or more buses. Hence, during margin testing, the removable clock-bypass card, 395 permits the external controller 220 to switch operational clock frequencies without physically removing and reinserting the modified system boards 250x. In this sense, margin testing is simplified because the operational clock frequency may be changed by the external controller 220 using external commands.

Since the operation of the modified system board 250x depends on correct timing, a user may wish to reset the system once the removable clock-bypass card 395 has been inserted into the modified system board 250x.

FIG. 3B is a block diagram showing a modified system board 250y having a clock-bypass circuit 350 in another embodiment. As shown in FIG. 3B, the modified system board 250y comprises a main clock 310 configured to generate a main clock signal 315. The main clock 310 is the default system clock that is used during normal operation (i.e., not during margin testing) of the modified system board 250y. Additionally, the modified system board 250y comprises a clock-selection circuit 320 having a MAIN CLOCK input, a SECONDARY CLOCK input, a SELECT input, and a SYSTEM CLOCK output. Since there is no secondary clock source during normal operation, the clock-selection circuit 320 receives the main clock signal 315, selects the main clock signal 315, and outputs the main clock signal 315 at the SYSTEM CLOCK output as the system clock signal 325 during normal operation.

While there are several different ways of implementing a clock-selection circuit 320, the clock-selection circuit 320 in one embodiment is implemented as a PLL circuit. The PLL circuit is configured to receive a clock-select signal 355 and two clock signals (e.g., a main clock signal 315 and a secondary clock signal 345). Upon receiving the two clock signals, the PLL circuit selects one of the two clock signals as the system clock signal 325 depending on the value of the clock-select signal 355.

In another embodiment, the clock-selection circuit 320 may be implemented using a two-input-one-output 2×1 MUX having a select node. In this sense, each of two clock signals is input to one of the two MUX inputs, and the clock-select signal 355 is input to the select node of the MUX. Thereafter, one of the clock signals is output at the MUX output depending on the value of the clock-select signal 355. Other similar circuits may be used as the clock-selection circuit 320 if the circuits are capable of (1) receiving at least two clock signals, (2) selecting one of the received clock signals, and (3) outputting the selected clock signal.

Continuing with the embodiment of FIG. 3B, the modified system board 250y further comprises a bridge 330 and a processor 340, which are configured to receive the system clock signal 325 from the clock-selection circuit 320. Thus, the operational clock speed of the bridge 330 and the processor 340 are determined by the system clock signal 325. The bridge 330 is electrically coupled to the processor 340 and a system bus 335, and the system bus 335 is coupled to various components on the modified system board 250y. In this sense, the bridge 330 interfaces the processor 340 to the various system components, thereby permitting the processor 340 to control the operations of each of the various components. Additionally, the system bus 335 is coupled to an I/O chip 397, which interfaces the modified system board 250y to the back-plane 140 through the electrical connector 160. In one embodiment, the various components include a plurality of dual-inline-memory module (DIMM) cards 390a, 390b, 390c, a controller card 385, a sound card 380, and various slots configured to receive peripheral devices. The various slots may include I/O slots 370a, 370b, 370c, an advanced graphics port (AGP) slot 375, and various other slots configured to engage peripheral devices.

A clock-bypass circuit 350 is included in the embodiment of FIG. 3B, thereby permitting the modified system board 250y to change clock sources without physical removal of the modified system board 250y from the back-plane 140. As shown in FIG. 3B, the clock-bypass circuit 350 is coupled to the back-plane 140 through a low-overhead bus 280. Since the back-plane 140 is accessible to the external controller 220 through the management board 130, the clock-bypass circuit 350 is also accessible to the external controller 220 since it is electrically coupled to the back-plane 140 through the low-overhead bus 280. In this sense, the external controller 220 may access the clock-bypass circuit 350 through the management board 130 and the back-plane 140.

In operation, the external controller 220 generates a clock-bypass command in order to switch the system clock of the modified system board 250y. The clock-bypass command is relayed to the clock-bypass circuit 350 through the management board 130 and the back-plane 140 via the low-overhead bus 280. Once the clock-bypass circuit 350 receives the clock-bypass command, the clock-bypass circuit 350 generates a clock-select signal 355 and a secondary clock signal 345. The generated secondary clock signal 345 and the clock-select signal 355 are relayed to the clock-selection circuit 320. At this point, the clock-selection circuit 320 receives the main clock signal 315, secondary clock signal 345, and the clock-select signal 355 at the MAIN CLOCK input, the SECONDARY CLOCK input, and the SELECT input, respectively. In an alternative embodiment, the secondary clock signal 345 may also be generated by an external clock (not shown), which directs the generated secondary clock signal 345 to the clock-selection circuit 320 of each system board through the backplane 140. In this regard, the external clock (not shown) may be co-located with the external controller 220 in one embodiment of the invention.

In response to receiving the clock-select signal 355 and the secondary clock signal 345, the clock-selection circuit 320 selects the secondary clock signal 345 as the system clock signal 325. The secondary clock signal 345 is then output from the clock-selection circuit 320 at the SYSTEM CLOCK output as the system clock signal 325. The operational clock frequency of the modified system board 250y is set by the system clock signal 325 for use by the bridge 330 and the processor 340. Hence, during margin testing, the clock-bypass circuit 350 permits the external controller 220 to switch operational clock frequencies without physically removing and reinserting the modified system boards 250y. In this sense, margin testing is simplified because the operational clock frequency may be changed by the external controller 220 using external commands.

Similar to the embodiment of FIG. 3A, since the operation of the modified system board 250y depends on correct timing, a user may wish to reset the system once the clock-bypass circuit 350 has been installed in the modified system board 250y. Similarly, the user may wish to reset the system when the clock frequency is changed in order to ensure proper timing during testing.

FIG. 3C is a block diagram showing a modified system board 270 having a clock-bypass circuit 350 in another embodiment. As shown in FIG. 3C, the modified system board 270 comprises a main clock 310 configured to generate a main clock signal 315. The main clock 310 is the default system clock that is used during normal operation (i.e., not during margin testing) of the modified system board 270. Additionally, the modified system board 270 comprises a clock-selection circuit 320 having a MAIN CLOCK input, a SECONDARY CLOCK input, a SELECT input, and a SYSTEM CLOCK output. During normal operation, the clock-selection circuit 320 receives the main clock signal 315, selects the main clock signal 315, and outputs the main clock signal 315 at the SYSTEM CLOCK output as the system clock signal 325.

While there are several different ways of implementing a clock-selection circuit 320, the clock-selection circuit 320 in one embodiment is implemented as a PLL circuit. The PLL circuit is configured to receive a clock-select signal 355 and two clock signals (e.g., a main clock signal 315 and a secondary clock signal 345). Upon receiving the two clock signals, the PLL circuit selects one of the two clock signals as the system clock signal 325 depending on the value of the clock-select signal 355.

In another embodiment, the clock-selection circuit 320 may be implemented using a 2×1 MUX having a select node. In this sense, each of two clock signals is input to one of the two MUX inputs, and the clock-select signal 355 is input to the select node of the MUX. Thereafter, one of the clock signals is output at the MUX output depending on the value of the clock-select signal 355. Other similar circuits may be used as the clock-selection circuit 320 if the circuits are capable of (1) receiving at least two clock signals, (2) selecting one of the received clock signals, and (3) outputting the selected clock signal. Continuing with the embodiment of FIG. 3C, the modified system board 270 further comprises a bridge 330 and a processor 340, which are configured to receive the system clock signal 325 from the clock-selection circuit 320. Thus, the operational clock speed of the bridge 330 and the processor 340 are determined by the system clock signal 325. The bridge 330 is electrically coupled to the processor 340 and a system bus 335, and the system bus 335 is coupled to various components on the modified system board 270. In this sense, the bridge 330 interfaces the processor 340 to the various system components, thereby permitting the processor 340 to control the operations of each of the various components. The system bus 335 is further coupled to an I/O chip 397, which interfaces the modified system board 270 to the back-plane 140 using an electrical connector 160. In one embodiment, the various components include a plurality of DIMM cards 390a, 390b, 390c, a controller card 385, a sound card 380, and various slots configured to receive peripheral devices. The various slots may include I/O slots 370a, 370b, 370c, an AGP slot 375, and various other slots configured to engage peripheral devices.

A clock-bypass circuit 350 included in the embodiment of FIG. 3C permits the modified system board 270 to change clock sources without physical removal of the modified system board 270 from the back-plane 140. As shown in FIG. 3C, the clock-bypass circuit 350 is coupled to a clock-select bus 290, which is directly coupled to an external controller 220. In this sense, the external controller 220 may directly access the clock-bypass circuit 350 through the clock-select bus 290 without having to access the management board 130 or the back-plane 140.

In operation, the external controller 220 generates a clock-bypass command in order to switch the system clock of the modified system board 270. The clock-bypass command is relayed to the clock-bypass circuit 350 through the clock-select bus 290. Once the clock-bypass circuit 350 receives the clock-bypass command, the clock-bypass circuit 350 generates a clock-select signal 355 and a secondary clock signal 345. The generated secondary clock signal 345 and the clock-select signal 355 are relayed to the clock-selection circuit 320. At this point, the clock-selection circuit 320 receives the main clock signal 315, the secondary clock signal 345, and the clock-select signal 355 at the MAIN CLOCK input, the SECONDARY CLOCK input, and the SELECT input, respectively. In response to receiving the clock-select signal 355 and the secondary clock signal 345, the clock-selection circuit 320 selects the secondary clock signal 345 as the system clock signal 325. The secondary clock signal 345 is then output from the clock-selection circuit 320 at the SYSTEM CLOCK output as the system clock signal 325. The operational clock frequency of the modified system board 270 is set by the system clock signal 325 for use by the bridge 330 and the processor 340. Hence, during margin testing, the clock-bypass circuit 350 permits the external controller 220 to switch operational clock frequencies without physically removing and reinserting the modified system boards 270. In this sense, margin testing is simplified because the operational clock frequency may be changed by the external controller 220 using external commands.

Similar to the embodiments of FIGS. 3A and 3B, since the operation of the modified system board 270 depends on correct timing, a user may wish to reset the system once the clock-bypass circuit 350 has been installed in the modified system board 270. Similarly, the user may wish to reset the system upon changing the operational frequency in order to ensure proper timing during testing.

While the embodiment of FIG. 3A shows the removable clock-bypass card 395 being implemented in the modified system board 250x of FIG. 2A, the removable clock-bypass card 395 may also be implemented in the modified system board 270 of FIG. 2B.

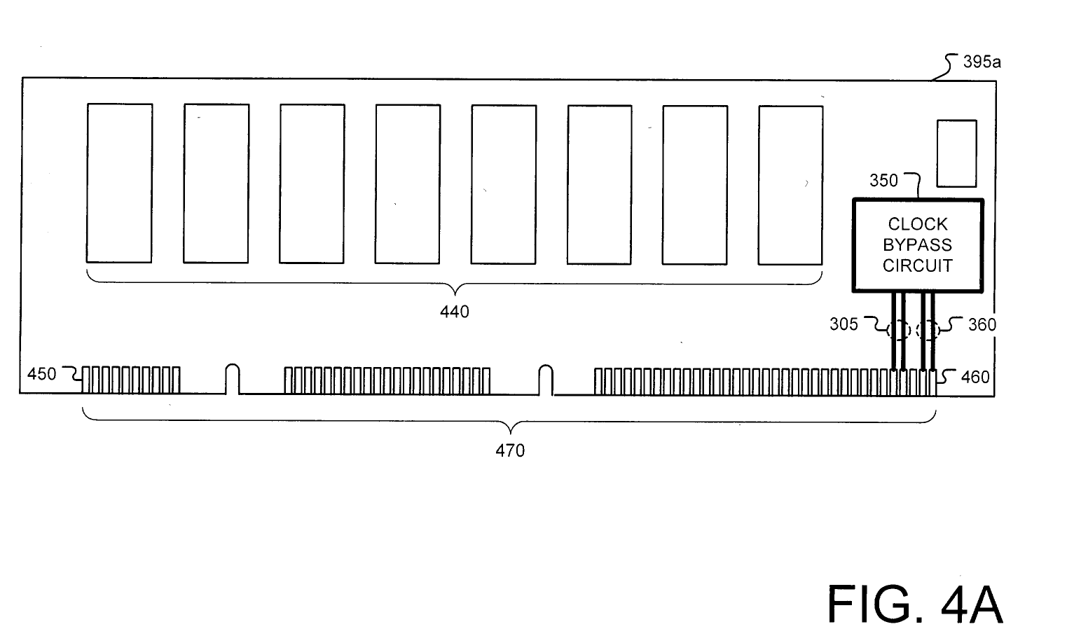

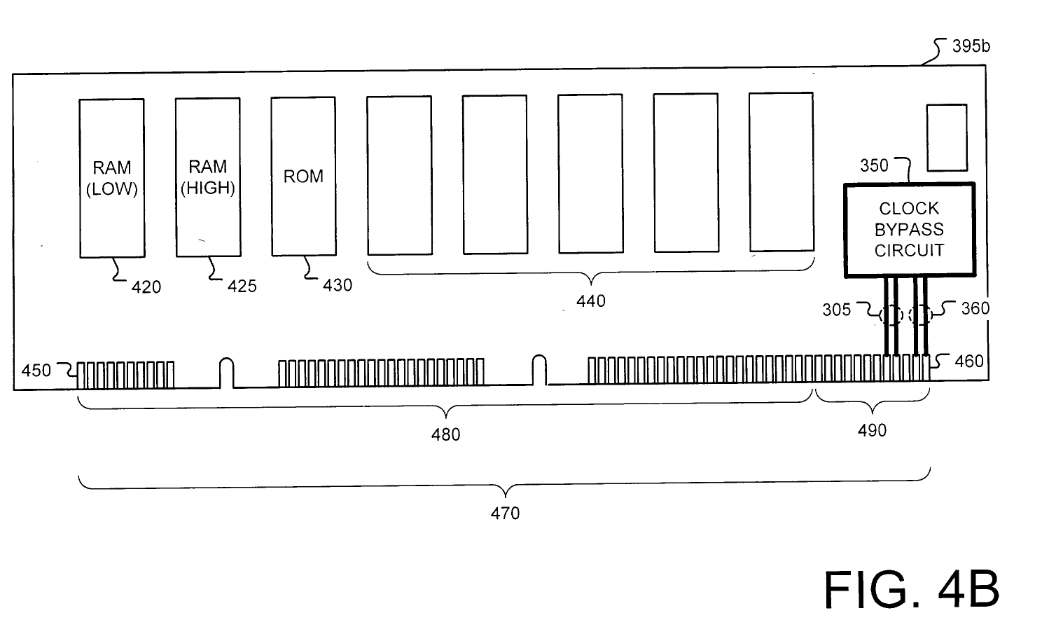

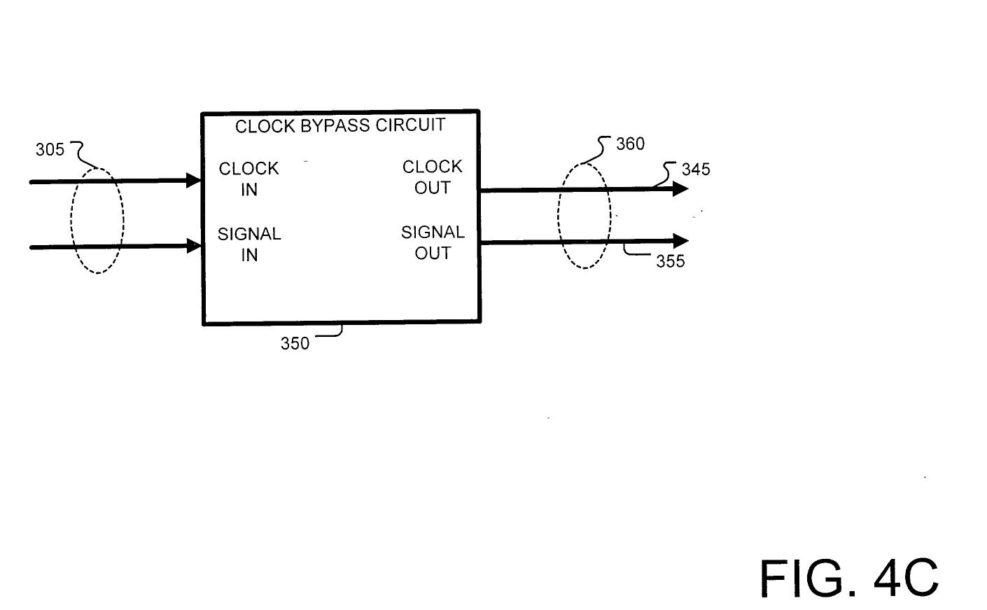

FIG. 4A is a block diagram showing one embodiment of the removable clock-bypass card 395a. As shown in FIG. 4A, the removable clock-bypass card 395a comprises a plurality of apertures 440 that may be used to host a clock-bypass circuit 350. Additionally, the removable clock-bypass card 395a comprises a plurality of pins 470 that are configured to engage the modified system board 250x. In the embodiment of FIG. 4A, the end aperture of the removable clock-bypass card 395a is shown as hosting the clock-bypass circuit 350. The clock-bypass circuit 350 includes a pair of input lines 305 and a pair of output lines 360, which are shown in greater detail in FIG. 4C. By having the clock-bypass circuit 350 on a removable clock-bypass card 395a, the hardware needed for margin testing may be removed after the testing is complete. In this sense, no additional hardware is present after testing once the removable clock-bypass card 395a is removed from the modified system board 250x. This permits margin testing by simply inserting the removable clock-bypass card 395a only when margin testing of a system board is desired.

FIG. 4B is a block diagram showing another embodiment of the removable clock-bypass card 395b. Unlike FIG. 4A, the embodiment of FIG. 4B shows a clock-bypass circuit 350 is “piggy-backed” onto a removable card having functional components. Specifically, in the example implementation of FIG. 4B, the clock-bypass circuit 350 is added to a DIMM card having random access memory (RAM) chips 420, 425, a read-only memory (ROM) chip 430, and a variety of other apertures 440 configured to receive additional chips. In this sense, if the removable clock-bypass card 395b has previously unused pins 490, then these previously unused pins 490 may be used to relay signals back and forth between the clock-bypass circuit 350 and the modified system board 250x. In the embodiment of FIG. 4B, one of the end apertures is shown as hosting the clock-bypass circuit 350.

The clock-bypass circuit 350 includes a pair of input lines 305 and a pair of output lines 360, which are coupled to several of the previously unused pins 490. By having the clock-bypass circuit 350 on a removable clock-bypass card 395b with functional components, a separate card interface is not needed on the modified system board 250x for the removable clock-bypass card 395. Furthermore, since the clock-bypass circuit 350 is placed on a removable clock-bypass card 395, the removable clock-bypass card 395 may be removed and a standard removable card may be inserted when margin testing is finished. In this sense, no additional hardware is present after testing once the standard removable card replaces the removable clock-bypass card 395b. This permits margin testing by simply substituting the removable clock-bypass card 395b for a standard removable card only when margin testing of a system board is desired.

FIG. 4C is a block diagram showing one embodiment of the clock-bypass circuit of FIG. 3B in greater detail. As shown in FIG. 4C, the clock-bypass circuit 350 comprises two input nodes 305 and two output nodes 360. The two input nodes 305 are a CLOCK IN node and a SIGNAL IN node, and the two output nodes 360 are a CLOCK OUT node and a SIGNAL OUT node.

The CLOCK IN node is configured to receive a clock signal, the SIGNAL IN node is configured to receive a command signal, the CLOCK OUT node is configured to output the secondary clock signal 345, and the SIGNAL OUT node is configured to output the clock-select signal 355. The command signal indicates to the clock-bypass circuit 350 whether or not the operating margins of the modified system board 250x, 250y, 270 are being tested. In this sense, the command signal is generated by the external controller 220.

In one embodiment, the clock signal and the command signal are generated by the external controller 220 and supplied to the clock-bypass circuit 350 using an inter-integrated circuit (I2C) protocol, developed by Philips Semiconductors. The I2C protocol is advantageous because the I2C protocol requires only two active wires (data and clock) and a ground connection. Since the I2C protocol is well-known in the art, further discussion of I2C is omitted here.

Page 18

In one embodiment, a high signal (e.g., binary “1”) at SIGNAL IN is used to indicate that the operating margins of the modified system boards 250x, 250y, 270 are being tested. Conversely, a low signal (e.g., binary “0”) or the absence of a signal at SIGNAL IN is used in this embodiment to indicate normal operation of the modified system boards 250x, 250y, 270. Furthermore, in this embodiment, the received clock signal at CLOCK IN has an operational clock frequency that is desired for margin testing.

If the command signal received at SIGNAL IN is high, then the clock-bypass circuit 350 is notified of margin testing. Subsequently, the received clock signal is relayed directly to the CLOCK OUT node as the secondary clock signal 345 without further modification, and a clock-select signal 355 is generated at SIGNAL OUT of the clock-bypass circuit 350. The secondary clock signal 345 and the clock-select signal 355 are input to the clock-selection circuit 320, and the secondary clock signal 345 is selected as the system clock signal 325. Thus, when the command signal is high; the secondary clock signal 345 dictates the operational frequency of the modified system boards 250x, 250y, 270.

On the other hand, if the command signal is low, then no output is generated at the CLOCK OUT node. Thus, the operational clock frequency of the modified system boards 250x, 250y, 270 is dictated by the main clock signal 315.

As shown in FIGS. 2A through 4C, the clock-bypass circuit 350 and the clock-selection circuit 320 permit margin testing without the inconvenience of physically removing and reinserting system boards. Thus, testing time is drastically decreased by permitting changes in operational clock frequency using external commands. Additionally, failures arising from physical tampering with system boards decreases concomitantly by permitting external control of operational clock frequencies.

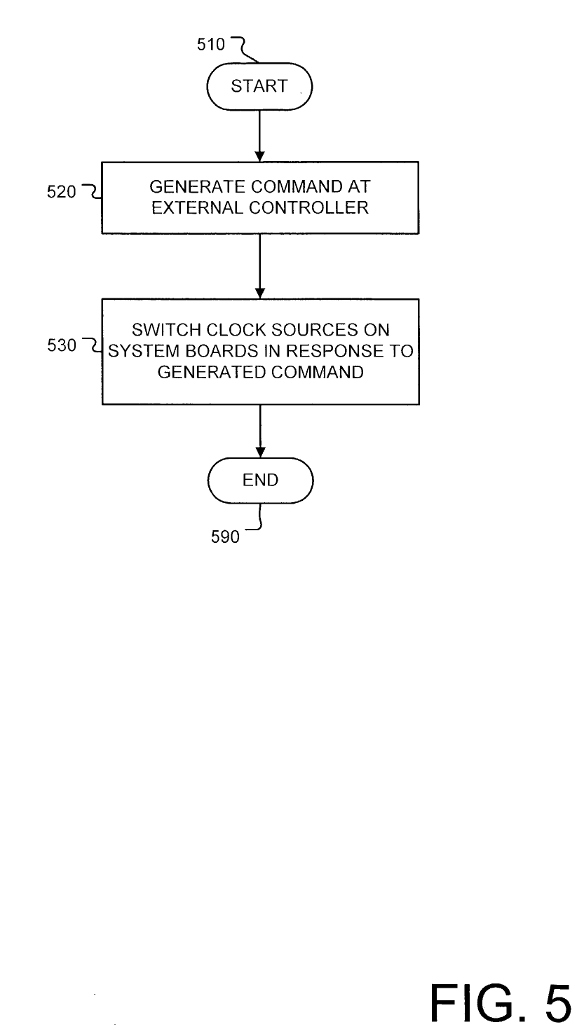

Having described various embodiments of the system, attention is now turned to FIGS. 5 through 7, which show several embodiments of clock source switching methods.

FIG. 5 is a flowchart showing one embodiment of a method for clock source switching, which may be performed by an external controller 220 and a multi-system chassis 210. As shown in FIG. 5, one embodiment of the method begins by generating (520) a command at an external controller 220. The generated command is received by each of the system boards, which switch (530) their clock sources in response to the generated commands. While the systems shown in FIGS. 2A through 4C may be used to implement the generating (520) of the command, any device that generates a clock signal and a command signal may be used to generate the command. Additionally, while the systems of FIGS. 2A through 4C may be used to switch (530) the clock source on the system boards, the clock sources may also be switched by any system configured to receive a command signal and generate a clock signal in response to the received command signal. In this sense, the method of FIG. 5 is not limited to the systems of FIGS. 2A through 4C.

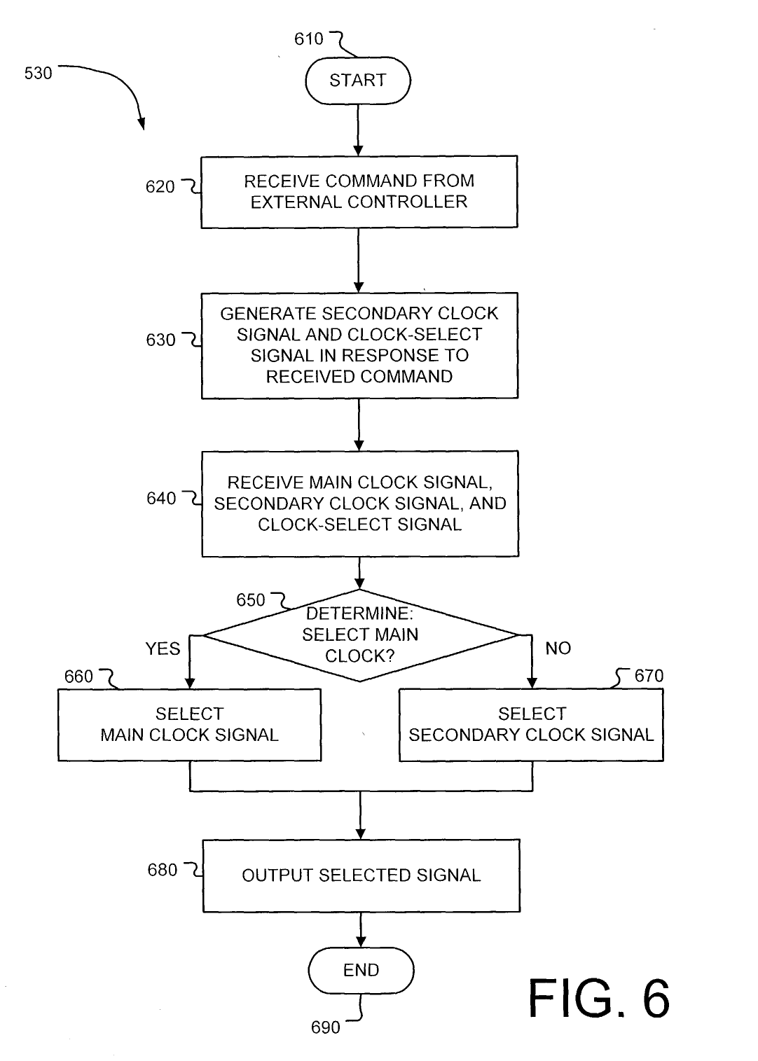

FIG. 6 is a flowchart showing one embodiment of a method for clock source switching, which may be performed by modified system boards 250x, 250y. Since a system board typically has a main clock 310 configured to generate a main clock signal 315, the process of generating a main clock signal 315 is not shown in FIG. 6. As such, the process of FIG. 6 begins when a command from an external source 220 is received (620). In response to receiving the command from the external source 220, a secondary clock signal 345 and a clock-select signal 355 are generated (630) and relayed to a clock-selection circuit 320. The secondary clock signal 345, the clock-select signal 355, and the main clock signal 315 are received (640) by a clock-selection circuit 320. As described above, the received clock-select signal 355 indicates whether the system board is operating normally, or whether margin testing is being performed on the system board. Thus, depending on the value of the received clock-select signal 355, the clock-selection circuit 320 determines (650) whether or not to select the main clock 310 as the system clock.

If the clock-selection circuit 320 determines that the system board is in normal operating mode, then the main clock signal 315 is selected (660) as the system clock signal 325. If, on the other hand, the clock-selection circuit 320 determines that margin testing is being performed on the system board, then the secondary clock signal 345 is selected (670) as the system clock signal 325. Either the main clock signal 315 or the secondary clock signal 345 is outputted by the clock-selection circuit 320 depending on which of the two signals is chosen. Thus, in one embodiment, the main clock 310 dictates the operational clock frequency during normal operation, while the clock signal from the external controller 220 dictates the operational clock frequency during margin testing.

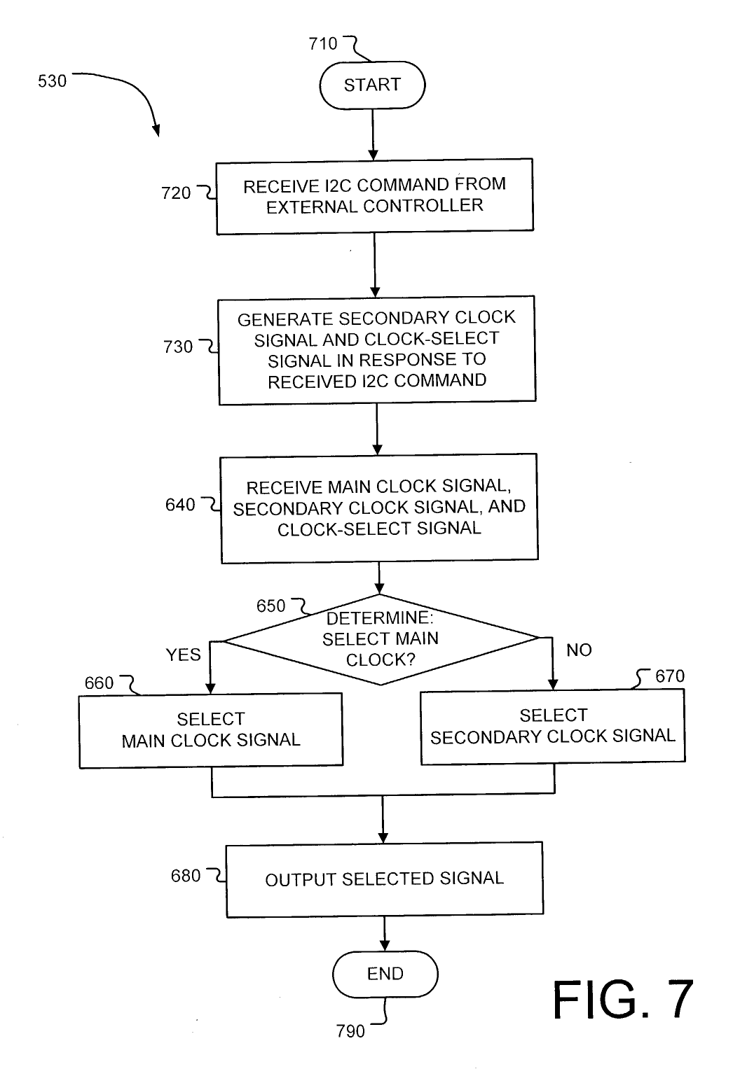

FIG. 7 is a flowchart showing another embodiment of a method for clock source switching, which may be performed by modified system boards 250x, 250y. In the embodiment of FIG. 7, the I2C protocol (developed by Philips Semiconductors) is used to convey a command from the external controller 220 to a modified system board 250x, 250y. Since the I2C protocol is well-known in the art, further discussion of I2C is omitted here. Since a system board typically has a main clock 310 configured to generate a main clock signal 315, the process of generating a main clock signal 315 is not shown in FIG. 7. As such, the process of FIG. 7 begins when an I2C command from an external source 220 is received (720). In response to receiving the I2C command from the external source 220, a secondary clock signal 345 and a clock-select signal 355 are generated (730) and relayed to a clock-selection circuit 320. The secondary clock signal 345, the clock-select signal 355, and the main clock signal 315 are received (640) by the clock-selection circuit 320. As described above, the received clock-select signal 355 indicates whether the system board is operating normally, or whether margin testing is being performed on the system board. Thus, depending on the value of the received clock-select signal 355, the clock-selection circuit 320 determines (650) whether or not to select the main clock 310 as the system clock.

If the clock-selection circuit 320 determines that the system board is in normal operating mode, then the main clock signal 315 is selected (660) as the system clock signal 325. If, on the other hand, the clock-selection circuit 320 determines that margin testing is being performed on the system board, then the secondary clock signal 345 is selected (670) as the system clock signal 325. Either the main clock signal 315 or the secondary clock signal 345 is outputted by the clock-selection circuit 320 depending on which of the two signals is chosen. Thus, in one embodiment, the main clock 310 dictates the operational clock frequency during normal operation, while the clock signal from the external controller 220 dictates the operational clock frequency during margin testing.

The clock-bypass circuit 350 and the clock-selection circuit 320 may be implemented in hardware using any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts may represent modules, segments, or portions of code which include one or more executable instructions for implementing specific logical functions or steps in the disclosed processes. These functions or steps may be executed out of order from that shown or discussed, including substantially concurrently or in reverse order, depending on the functionality involved.

Although exemplary embodiments have been shown and described, it will be apparent that a number of changes, modifications, or alterations may be made. All such changes, modifications, and alterations should therefore be seen as being within the scope of the present invention.

What is claimed is:

1. A clock-source-switching system comprising:
an external controller configured to generate an inter-integrated circuit (I2C) command;
a back-plane electrically coupled to the external controller, the back-plane having a plurality of system board receptacles, the back-plane being configured to receive the I2C command from the external controller and relay the I2C command using the plurality of system board receptacles;
a plurality of system boards, each system board comprising:
a low-overhead bus configured to engage one of the plurality of system board receptacles of the back-plane, the low-overhead bus being configured to receive the I2C command from the back-plane;
a main clock configured to generate a main clock signal;
a clock-bypass circuit configured to receive the I2C command and generate a secondary clock signal and a clock-select signal in response to the received I2C command; and
a clock-selection circuit configured to receive the secondary clock signal and the clock-select signal from the clock-bypass circuit, the clock-selection circuit further being configured to receive the main clock signal from the main clock and select either the main clock signal or the secondary clock signal in response to the clock-select signal.

2. The system of claim 1 further comprising a clock bypass card interposed between the low-overhead bus and the clock-selection circuit, the clock bypass card configured to host the clock-bypass circuit.

3. A clock-source-switching system comprising:
a low-overhead bus configured to receive a command from an external controller;
a main clock configured to generate a main clock signal;
a clock-bypass circuit configured to receive the command and generate a secondary clock signal and a clock-select signal in response to the received command; and
a clock-selection circuit configured to receive the secondary clock signal and the clock-select signal from the clock-bypass circuit and receive the main clock signal from the main clock, the clock-selection circuit further being configured to select either the main clock signal or the secondary clock signal in response to the clock-select signal.

4. The system of claim 3 wherein the low-overhead bus is directly coupled to the external controller.

5. The system of claim 3, wherein the low-overhead bus is further configured to receive a command from an external controller through a management board.

6. The system of claim 5, wherein the low-overhead bus is further configured to receive a command from an external controller through a management board via a back-plane.

7. The system of claim 3, further comprising a clock bypass card interposed between the low-overhead bus and the clock-selection circuit, the clock bypass card configured to host the clock-bypass circuit.

8. The system of claim 7, wherein the clock-bypass card comprises:
an input node configured to receive the commands;
a clock-output node configured to output the secondary clock signal; and
a clock-select-output node configured to output the clock-select signal.

9. The system of claim 3, wherein the clock-bypass circuit is further configured to receive the command using an inter-integrated circuit (I2C) protocol.

10. The system of claim 9, wherein the clock-bypass circuit is further configured to generate the secondary clock signal and the clock-select signal in response to the received I2C-protocol signal.

11. The system of claim 3, wherein the clock-selection circuit comprises a phase-locked loop (PLL) circuit configured to receive the main clock signal, the secondary clock signal, and the clock-select signal.

12. The system of claim 3, wherein the clock-selection circuit comprises a multiplexer (MUX) configured to receive the main clock signal, the secondary clock signal, and the clock-select signal.

13. The system of claim 3, wherein the clock-selection circuit comprises:
a main-clock-signal input node configured to receive the main-clock signal;
a secondary-clock-signal input node configured to receive the secondary clock signal;
a clock-select-signal input node configured to receive the clock-select signal; and
a system-clock output node configured to output either the main clock signal or the secondary clock signal as a function of the clock-select signal.

14. In a system having a back-plane configured to receive a plurality of system boards, a clock-source switching method comprising:
generating a command from an external source; and
switching clock sources on each of the plurality of system boards in response to the generated command.

15. The method of claim 14, wherein the step of generating the command comprises generating a command using an inter-integrated circuit (I2C) protocol.

16. The method of claim 14, wherein the step of switching the clock sources comprises:
receiving the command from the external source;
generating a secondary clock signal and a clock-select signal in response to the received command;
receiving the main clock signal, the secondary clock signal, and the clock-select signal;
selecting either the received main clock signal or the secondary clock signal in response to the value of the clock-select signal; and
outputting the selected signal.

17. The method of claim 16, wherein the step of receiving the command comprises receiving an inter-integrated circuit (I2C) command.

18. In a system having a back-plane configured to receive a plurality of system boards, each system board having a main clock configured to generate a main clock signal, a clock-source switching method comprising:
receiving a command from an external source;
generating a secondary clock signal and a clock-select signal in response to the received command;
receiving the main clock signal, the secondary clock signal, and the clock-select signal;
selecting either the received main clock signal or the secondary clock signal in response to the value of the clock-select signal; and
outputting the selected signal.

19. The method of claim 18, wherein the step of receiving the command comprises receiving an inter-integrated circuit (I2C) command.

20. In a system having a back-plane configured to receive a plurality of system boards, a clock-source switching system comprising:
means for generating a command from an external source; and
means for switching clock sources on each of the plurality of system boards in response to the generated command.

21. The system of claim 20 further comprising means for generating a command using an inter-integrated circuit (I2C) protocol.

22. The system of claim 20, wherein the means for switching the clock sources comprises:
means for receiving the command from the external source;
means for generating a secondary clock signal and a clock-select signal in response to the received command;
means for receiving the main clock signal, the secondary clock signal, and the clock-select signal;
means for selecting either the received main clock signal or the secondary clock signal in response to the value of the clock-select signal; and
means for outputting the selected signal.

23. The system of claim 22 further comprising means for receiving an inter-integrated circuit (I2C) command.

24. In a system having a back-plane configured to receive a plurality of system boards, each system board having a main clock configured to generate a main clock signal, a clock-source switching system comprising:
means for receiving a command from an external source;
means for generating a secondary clock signal and a clock-select signal in response to the received command;
means for receiving the main clock signal, the secondary clock signal, and the clock-select signal;
means for selecting either the received main clock signal or the secondary clock signal in response to the value of the clock-select signal; and
means for outputting the selected signal.

25. The system of claim 24 further comprising means for receiving an inter-integrated circuit (I2C) command.
